(19) United States
(12) Patent Application Publication
(10) Pub. No.: US 2008/0060032 A1
(43) Pub. Date: Mar. 6, 2008

(54) COMMUNICATION AND REMOTE EDITING OF DIGITAL PHOTOGRAPHS

(76) Inventor: Nico Toutenhoofd, Boulder, CO (US)

Correspondence Address: THE LAW OFFICE OF IDO TUCHMAN, 82-70 BEVERLY ROAD, KEW GARDENS, NY, 11415, US

(21) Appl. No.: 11/469,860

(22) Filed: Sep. 2, 2006

(51) Int. Cl. H04N 7/173; H04N 5/76

(52) U.S. Cl. 725/105; 348/231.2

(57) ABSTRACT

A system, method, and computer program product for selectively transmitting full-resolution digital images to a remote viewer from a field location. One embodiment includes connecting to a portable electronic device, receiving at least one full-resolution image from the portable electronic device, creating a reduced-sized image, transmitting the reduced-size image to a web server, receiving a request for the full-resolution image from the web server, and transmitting the full-resolution image to the web server.

### BACKGROUND OF THE INVENTION

The present invention relates generally to communication and remote editing of digital photographs as they are being captured at a field location.

Many news publications, both in print and online, include photographs relating to the stories they report. A photographer on assignment may shoot hundreds of photographs for a single story, of which only one or two photographs may be selected by a photo editor for publication. Often times, there is pressure on photographers when shooting deadline-driven assignments to take a large number of high-resolution photographs and deliver them back to the photo editor as quickly as possible. Moreover, the photo editor is likely located far from the photographer on the field, possibly in a different country.

One solution for delivering photographs to an editor is for “film runners” to physically transport the film or digital image files from the photographer in the field back to the photo editor. However, in situations such as when a photographer is in a remote, anonymous or hazardous location, using film runners may not be practical. Additionally, it may be much faster to deliver digital images electronically to the photo editor over an available network connection.

Network connections in field locations may not always provide a fast connection. Each high-resolution digital photograph may be several megabytes in size. In a location where there is a slow network connection (low bandwidth), transmitting hundreds of full-resolution images from the field location directly to the editor may take several hours.

One conventional technique for electronically transmitting photographs in low bandwidth field locations is for the photographer to review the images herself and transmit just a few photographs out of all the images taken. Thus, the photographer acts as a photo editor before the images are transmitted. The photographer, however, may not be the best person to select an appropriate photograph for a story.

Another solution is for photo editors to accompany the photographer(s) on assignment. The photo editor can then review the photographs as they are being shot and select only a few pictures for transmission back to the publishing facility. Sending a photo editor to the field location along with the photographers, however, may not always be practical or necessary.

### BRIEF SUMMARY OF THE INVENTION

Thus, one exemplary aspect of the present invention is a method for selectively transmitting full-resolution digital images to a remote viewer from a field location. The method includes a connecting operation for connecting to a portable electronic device at the field location. A receiving operation receives, at the field location, at least one full-resolution image from the portable electronic device. The full-resolution image has a full-resolution storage size. A creating operation creates at the field location a reduced-sized image. The reduced-sized image has a reduced storage size that is smaller than the full-resolution image storage size. A transmitting operation transmits, at the field location, the reduced-size image to a web server. The web server is configured to display the reduced-size image for selection of the full-resolution image by the remote viewer. Another receiving operation receives, at the field location, a request for the full-resolution image from the web server. A transmitting operation transmits, at the field location, the full-resolution image to the web server. The web server is further configured to transmit the full-resolution image to the remote viewer.

Another exemplary aspect of the invention is a portable data manager for selectively transmitting full-resolution digital images to a remote viewer from a field location. The data manager includes an image receiving unit configured to receive, at the field location, at least one full-resolution image having a full-resolution storage size from the portable electronic device. A local memory unit is configured to store received and created images. An image reducing unit is configured to create a reduced-sized image having a storage size that is smaller than the full-resolution image storage size. An image transmitting unit is configured to send the reduced-sized image and full-resolution image. A command receiving unit is configured to receive a request for the full-resolution image. An image transmission unit is configured to transmit the full-resolution image in response to a request for the full-resolution image.

Yet a further exemplary aspect of the invention is a computer program product embodied in computer readable memory for selectively transmitting full-resolution digital images to a remote viewer from a field location. The computer program product includes program code for connecting to a portable electronic device, receiving at least one full-resolution image from the portable electronic device, creating a reduced-sized image, transmitting the reduced-size image to a web server, receiving a request for the full-resolution image from the web server, and transmitting the full-resolution image to the web server.

### BRIEF DESCRIPTION OF THE SEVERAL VIEWS OF THE DRAWINGS

FIG. 1 shows an exemplary environment embodying the present invention.

FIG. 2 shows exemplary modules forming one embodiment of the data manager contemplated by the present invention.

FIG. 3 illustrates the flow chart of systems operations preformed by the data manager when a new full-resolution image is received.

FIG. 4 shows a flow chart of exemplary system operations preformed by the data manager when a command is received.

FIG. 5 shows a flow chart of exemplary system operations preformed by a web server when an image is received.

FIG. 6 is a chart illustrating exemplary system operations preformed by a digital storage unit, data manager, web server and remote viewer.

### DETAILED DESCRIPTION OF THE INVENTION

The following description details how the present invention is employed to allow a remote viewer to select for download high-resolution images from a field location.

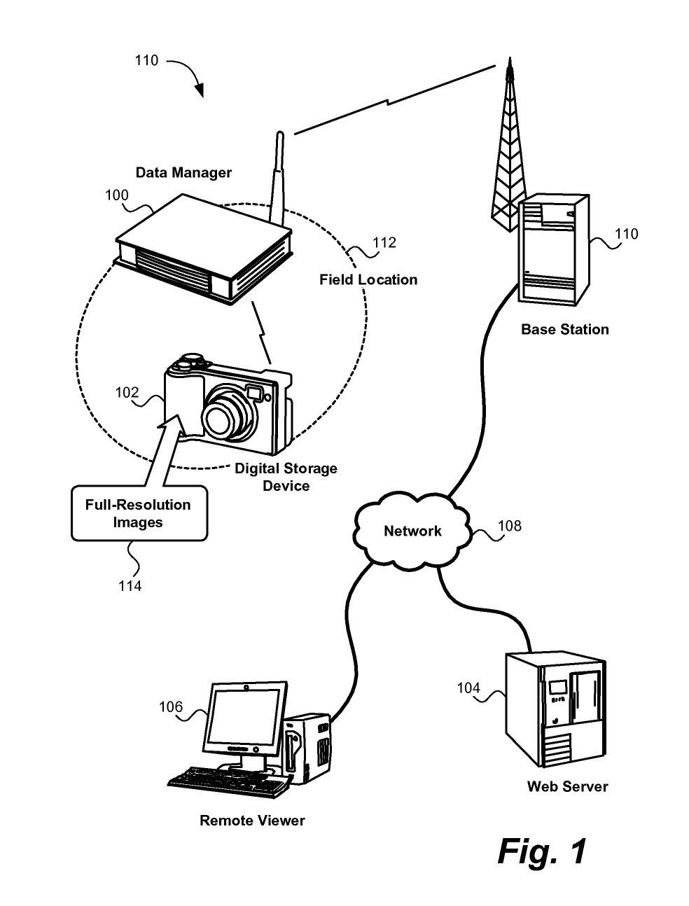

FIG. 1 shows an exemplary environment 110 embodying the present invention. It is initially noted that the environment 110 is presented for illustration purposes only, and is representative of various configurations in which the invention may be implemented. Thus, the present invention should not be construed as limited to the environment configurations shown and discussed herein.

The environment 110 includes a digital camera 102 coupled to a portable data manager 100, both of which are located at a field location 112. In one embodiment of the invention, a photographer at the field location 112 photographs full-resolution images 114. As described in more detail below, a remote viewer 106, such as a newspaper editor, can quickly receive and review previews of the full-resolution images 114 via the data manager 100, a base station 110, and a web server 104. Once the remote viewer 106 selects the desired images, the data manager 100 automatically transmits the full-resolution images 114 to the remote viewer 105 for publication.

The environment 110 can assist in quickly delivering images, video and sounds (referred to collectively as multimedia data) of events at a field location 112 to remote news editors and other viewers. For example, a photographer working for a news organization may photograph a news worthy event, such as a speech delivered by a politician or a natural disaster, at a field location 112. The photographer may utilize the present invention to rapidly transmit preview images to a news editor located in another city or country.

The preview images are smaller than the full-resolution images and take less time to electronically send to the editor 105. Using the preview images, the editor can decide which full-size images to receive from the photographer at the field location. Once a selection request is received by the data manager 100, the selected full-size images are given transmission priority for delivery to the editor.

The present invention can beneficially conserve bandwidth in field locations where access to a high speed connection to a wide area network may not exist. Bandwidth is conserved by transmitting reduced-size images to the remote viewer. Moreover, after one or more images are selected by the remote viewer, the selected images are given transmission priority to the remote viewer. In this manner, selected images are delivered more rapidly to the remote viewer than non-selected images.

Before describing the invention in more detail, it will be appreciated by one skilled in the art that the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Returning to FIG. 1, the digital storage device 102 is a portable electronic device that includes memory for storing multimedia data such as images, video and audio recordings. This memory is typically non-volatile memory, such as magnetic disc memory, optical disc memory, solid-state memory (such as flash and PRAM memory), and other memory technologies known to those skilled in the art.

The data stored on the digital storage device 102 may be encoded using various formats known to those skilled in the art. For example, images stored in the digital storage device 102 may be formatted under the Joint Photographic Experts Group (JPEG) compression method. Video content may be formatted under the various Moving Picture Experts Group (MPEG) encoding methods, such as MPEG-1. Sound recordings may be stored in MPEG-1 Audio Layer 3 (MP3) format. It should be understood that the various other content formats may be used by the data manager 102 without departing from the scope of the present invention.

In a particular embodiment of the invention, the digital storage device 102 is a digital camera. Modern digital cameras typically capture images in large high-resolution files that are many megabytes in size. These large image files originating from the digital storage device 102 are referred to herein as “full-resolution” images. In another embodiment of the invention, the digital storage device 102 is any digital device that is capable of transmitting multimedia data. Examples of such devices are video recorders, cellular telephones, Personal Data Assistants (PDA), and MP3 players.

The data manager 110 is coupled to the digital storage device 102 and receives the full-resolution images stored therein. The digital storage device 102 and the data manager 100 can communicate with each other using wired and/or wireless communication techniques. Such techniques include USB, FireWire, WiFi and Blue Tooth, as well as other techniques known to those skilled in the art.

For example, modern digital cameras have various ways of storing and transmitting full-resolution images. A digital camera often contains a removable memory card, such as a flash memory card, or another memory technology known to those in the art. The removable memory card can then be removed and placed inside the data manger 100 to allow it to access the full-resolution images. Modern digital cameras can also include physical and wireless interface ports, such as USB, FireWire, WiFi and Blue Tooth, which permit communications between the data manger 100 and the camera. These ports allow for the transmission of full-resolution images from the camera to the data manager 100.

It is contemplated that the data manager 100 may be capable of communicating with more than one digital storage device 102 at a time. Thus, the data manager 100 may form a Local Area Network (LAN) or piconet between several digital storage devices.

In one embodiment of the invention, the data manager 100 is configured to receive both textual and/or audio data associated with a particular full-resolution image. Such data may be utilized as an image caption to describe important details about the associated image. For example, textual comments can be associated with an image to allow a remote viewer 106 to understand what is being presented in the image. In another embodiment, audio data can be associated with an image that may incorporate a short narrative explaining to the remote viewer 106 what is shown in the image.

As mentioned above, the digital storage device 102 and the portable data manager 100 are located at a field location 112. As used herein, the term “field location” is defined as a geographic location where both the digital storage device 102 and the data manager 100 are located such that the devices can communicate with each other via a wired or wireless communication link. Typically, the field location is a geographic location where a direct high-speed connection from the digital storage device 102 to a wide area computer network 108 is impractical due to a lack of infrastructure or a lack of time.

The data manager 100 and digital storage device 102 do not need to be in close proximity at all times, however, they should eventually be in close enough proximity to allow for the communication between the digital storage device 102 and the data manager 100. While a communication link exits between the digital storage device 102 and the data manager 100, the data stored in the digital storage device 102 is transferred from the digital storage device to the data manager. The role of the communication link between the data manager 100 and the digital storage device 102 is further discussed below.

Once the data manager 100 receives new full-resolution images, it creates reduced-size images of the full-resolution images and establishes a communication link to a base station 110. In one particular embodiment, the data manager 100 and the base station 110 communicate using a wireless communication link. This wireless link, for example, may be created using a cellular modem through a national cellular network.

Code Division Multiple Access (CDMA) is one popular cellular network protocol that can be used to communicate with the base station 110. Time Division Multiple Access (TDMA) is another popular cellular network protocol that can be used to communicate with the base station 110. Regardless of the protocol employed by the cellular modem, the cellular modem's primary job is to provide communication capabilities between the data manager 100 and the base station 110.

The communication medium between the data manager 100 and the base station 110 is not necessarily limited to a cellular communication. For example, the communication medium could consist of a wired or optical network. Various communication mediums known to those skilled in the art could be copper wire such as Cat5, Cat5E, Cat6, etc. Fiber optic or infrared (IR) could also be used as a communication medium.

The base station 110 is connected to a computer network 108. The computer network 108 may be a Local Area Network (LAN), a Wide Area Network (WAN), a piconet, or a combination thereof. It is contemplated that the computer network 108 may be configured as a public network, such as the Internet, and/or a private network, such as an Intranet or other proprietary communication system. Various topologies and protocols known to those skilled in the art may be exploited by the network 108, such as WiFi, Bluetooth®, TCP/IP, UDP, GSM, TDMA and CDMA. Bluetooth is a registered trademark of Bluetooth SIG, Inc., Bellevue, Wash. Furthermore, the network 108 may include various networking devices known in the art, such as routers, switches, bridges, repeaters, etc.

A web server 104 is coupled to the computer network 108. The data manager 100 transmits the reduced-size images to a web server 104 via the base station 110 and computer network 108. The web server 104 is configured to display the reduced-size images to the remote viewer 106. In one embodiment, the web server 108 hosts web pages that include the reduced-size images. These web pages are accessible to the remote viewer 106 through the computer network 108.

The remote viewer 106 interacts with the web server 104 using a computer, or other such device that contains a web browser. Examples of such web browsers are Internet Explorer, Netscape, and FireFox. It is contemplated that the remote viewer 106 is not limited to one remote viewer 106 but can be various remote viewers all connected to a network 108. Using a web browser or other interface, the remote viewer 106 is able inspect the reduced-size images and instruct the web server 104 to perform various actions. Such actions include the retrieval of full-resolution images or the selective cropping of a particular image.

In one particular embodiment of the invention, the web server 104 is further configured to create thumbnail images of the reduced-size images it receives from the data manager 100. A thumbnail image is an image whose size has been reduced to allow for multiple thumbnail images to be displayed on a display. Both the thumbnail images and reduced-sized images are available for a remote viewer 106 to view. Thus, a remote viewer 106 may decide to view the thumbnail images currently stored on the web server.

Based on the thumbnail images and/or the reduced-sized image, the remote viewer 106 can send a request to the web server 104 for the full-resolution image. If the web server 104 does not already contain the data requested, the web server 104 sends a request to the data manager 100 via a base station 110. The base station 110 communicates with the data manager 100 wirelessly, such that the data manager 100 and digital storage device can remain in the field location during data exchanges with the base station 110. In response to the web serve's request, the data manager 100 sends the full resolution image to the web server 104. The web server 104 is, in turn, configured to send the image to the remote viewer 106.

In a further embodiment of the invention, the remote viewer 106 may decide that only a portion of the full resolution image is needed. The remote viewer 106 can send cropping directives to the web server 104 which is further configured to relay these requests to the data manager 100. The data manager 100 crops the full resolution image and sends the cropped full-resolution image back to the web server 104. The web server 104 then transmits the cropped full-resolution image to the remote viewer 106.

It will be appreciated by those skilled in the art that, in general, the slowest data throughput from the digital storage device 102 to the remote viewer 106 will exist between the data manager 100 and the base station 110. As discussed below, the data manager 100 helps minimize the amount of data passed along this junction by automatically providing smaller “reduced-size images” to the remote viewer 106. Using the reduced-size images, the remote viewer 106 can preview the images before full-resolution images are uploaded from the digital storage device. Images of interest are prioritized during data exchanges between the data manager 100 and the remote viewer 106, with valuable bandwidth between the data manager 100 and the base station 110 more effectively utilized.

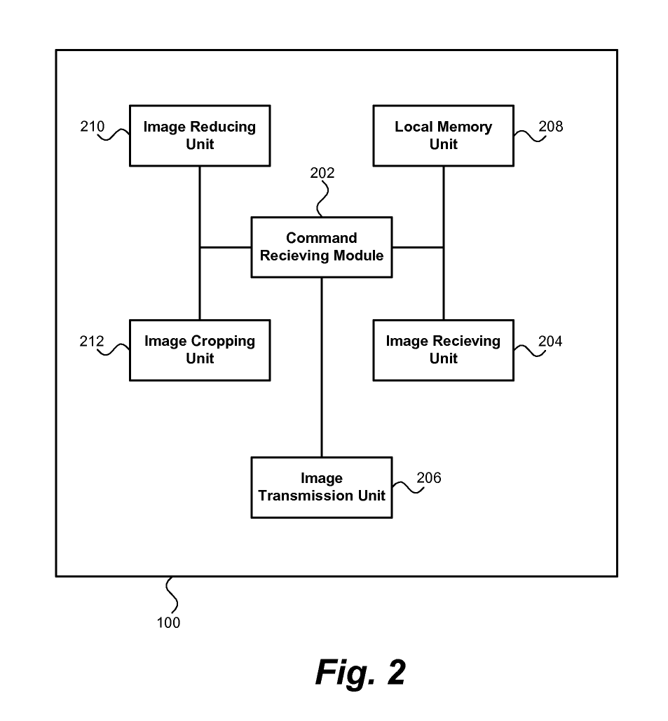

Turning to FIG. 2, exemplary modules forming one embodiment of the data manager 100 are shown. The modules shown may be implemented in hardware, software or as a combination of both. The implementation is a matter of choice dependent on the performance requirements of the system realizing the invention.

Central in the data manager arrangement is a command receiving module 202. The command receiving module 202 is configured to receive commands from a base station. The command receiving module 202 is further configured to pass commands received on to the appropriate modules. Such commands can be image copping directives which would be relayed to an image cropping unit 212. Another such command would be an image receiving directive which would alert an image receiving unit 204 to begin to receive a full-resolution image. Additional commands acted upon by the command receiving module 202 are detailed below.

A local memory unit 208 is configured to store binary information such as multimedia data. As noted above, multimedia data may include, but is not limited to text, images, video, and audio information. Furthermore, the local memory unit 208 may include program code for carrying out the data manager's operations. The local memory unit 208 may contain volatile memory, such as DRAM, and/or non-volatile memory, such as flash memory.

The image receiving unit 204 is configured to receive multimedia data including full-resolution images, video and audio from a digital storage device. The image receiving unit 204 is further configured to automatically detect when a new image (or other multimedia data) is available at the connected digital storage device. Upon detection of such available data, the image receiving unit 204 will copy the image to the local memory unit 208. In addition, the image receiving unit 204 notifies an image reducing unit 210 that a new image has been saved to local memory 208 by passing to the image reducing unit 210 a reference to the new image.

The image reducing unit 210 is configured to process a full-resolution image and compress it to form a reduced-sized image. The reduced-sized image has a smaller storage size than the full-resolution image. Such compression algorithms are known to those skilled in the art, and include the Joint Photographic Experts Group (JPEG) compression method. The image reducing unit 210 uses one or more compression methods to significantly reduce the amount of storage size occupied by the reduced-sized image. Once the reduced-sized image is created, the image reducing unit 210 stores this image in the local memory unit 208.

The image cropping unit 212 is configured to process a full-resolution image and crop, or remove a specific portion of it, to form a cropped full-resolution image. The cropped full-resolution image has a smaller dimensional size than the full-resolution image. The image cropping unit 212 may use various known image processing techniques to crop the portion of the unit requested by the user. The image reducing unit 210 then stores the new reduced-sized image in the local memory unit 208.

An image transmission unit 206 is configured to send to the web server the reduced-sized images in the local memory unit 208. The image transmission unit is also configured to send textual or audio captions that may be associated with the reduced-sized images. Furthermore, the image transmission unit 206 receives commands from the command receiving unit 202 instructing it to send full-resolution or cropped full-resolution images to the web server.

Since, as mentioned above, the slowest data throughput from the digital storage device to the remote viewer will generally occur between the data manager 100 and the base station, the image transmission unit 206 is further configured to automatically transmitting full-resolution images. When the image transmission unit 206 is idle, or not transmitting any full-resolution or reduced-sized images, it may be optionally configured to send unsent full-resolution images to the base station.

It is contemplated that the data manager 100 includes an internal priority queue to determine which images to send next to the web server. Because of the limited bandwidth between the data manager 100 and the base station, and the large size of the full-resolution images, it can take several minutes for a full-resolution image to be received by the web server.

Making this limitation more prevalent is a remote viewer's ability to select multiple full-resolution images for download. If, for example, after selecting multiple full-resolution images the remote viewer may decide that a particular full-resolution image should be received first, before the previously selected images. In an embodiment of the invention, the remote viewer instructs the data manger 100 to place a particular full-resolution image at a higher priority than a previously queued full-resolution image, enabling the data manager 100 to send the higher priority image ahead of the previously selected images.

The priority queue is also beneficial when the data manager 100 is busy sending un-requested and unsent full-resolution images to the base station. When a request for a full-resolution image is received from a remote viewer, the data manager 100 will place that request at a higher priority than the images currently being sent to the web server. This allows the remote viewers to request to take precedent over other tasks.

To aid in the transmission of large image files, multiple cellular modems, or connections to the base station, may be used. In one embodiment of the invention two Qualcomm 5220 EVDO PCMCIA CDMA modems may be used. To take advantage of the added bandwidth provided by using multiple modems, each transmitted image is segmented into several equal parts, one part for each modem. In one embodiment of the invention, the Unix “split” utility is used to segment the file into several equal parts.

For example, if two Qualcomm 5220 EVDO PCMCIA modems are used, the image will be segmented into two equal parts, each part sent through one of the cellular modems. The two parts of the image will then be reassembled at the web server 104. In one embodiment of the invention the Unix “cat” utility is used to reassemble the previously fragmented image.

In a particular embodiment of the invention, the operating system at data manager 100 is Metrix-Pebble (a variant of Debian Linux). It is contemplated, however, that various operating systems may be utilized by the data manager 100, such Microsoft Windows, Apple's OS X, and various versions of Unix or Linux. The data manager 100 can also use MadWiFi to establish the LAN with digital storage device.

The data manager 100 processes “jobs” in order of priority. High priority jobs are performed first. When a new image arrives from the digital storage device, two new jobs are created: a high priority job to create and send the preview image, and a low priority job to send the full-resolution image.

Assuming, for example, that the data manager 100 requires approximately six seconds to upload a preview image and three minutes to upload a full-resolution image. If a photographer is rapidly shooting new images, the data manager 100 will be constantly processing the higher priority jobs of creating and sending the preview images. But if the photographer is shooting slowly enough that the data manager 100 runs out of preview images to send, it will start to process the lower priority jobs and upload the large full-resolution files.

While processing jobs, the data manager 100 continually checks to see if there are any higher priority jobs that it should be working on. If a higher priority job is created, the data manager 100 quits its current job and starts the higher priority job. Once the newly created higher priority job is completed, the data manager 100 resumes the lower priority job.

If a photo editor requests a full-resolution image from the data manager 100, he or she can specify whether this request should take priority over the sending of preview images, or if it should be the highest priority job other than preview images. Thus, the data manager 100 may receive a priority level for transmitting, at the field location 112, the full-resolution image to the remote viewer 106.

Based on the assumption that it takes six seconds to upload a preview image and three minutes to upload a full-resolution image:

1—If the photographer shoots more than ten images per minute, the data manager 100 will continually be sending preview images and will never get to process the lower full-resolution images.

2—If the photographer shoots less than one image every three minutes and six seconds, every preview image and full-resolution image will get uploaded.

3—More likely, the photographer will average shooting somewhere between ten images per minute and one image per three minutes, and every preview image and a few full-resolution images will be sent by the data manager 100.

In this configuration, the data manager 100 does not sitting idle. Rather it is continuously sending data to the web server. If the photo editor requests an image that has been completely or even partially uploaded, this configuration will greatly reduce the amount of time it takes to retrieve the remainder of that file.

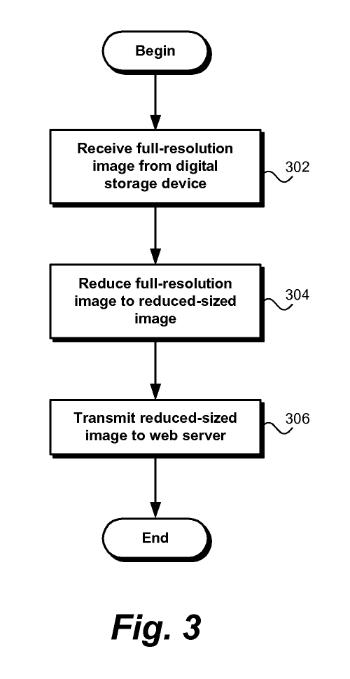

In FIG. 3, a flow chart of exemplary systems operations preformed by the data manager when a new full-resolution image is received is shown. Operational flow begins with receiving operation 302. During this operation, the full-resolution image is sent from the digital storage device, such a device includes a digital camera. The image may be sent wirelessly through protocols like Bluetooth or WiFi or they may be transferred using wired protocols such as USB or Ethernet. In one embodiment of the invention, WiFi (IEEE 802.11g) is used to transmit the image. The image is fragmented into many parts and encapsulated into TCP/IP packets. These TCP/IP packets are reassembled by the data manager. Once all of the TCP packets have been assembled the full-resolution image is stored in its entirety to local memory, and the process flow continues to reducing operation 304.

At image reducing operation 304, a reduced-sized image of the full-resolution image is created. The reduced-sized image is a compressed version of the full-resolution image. The image can be formatted by the Joint Photographic Experts Group (JPEG) compression standard or another popular compression scheme. It is contemplated that the data manager can use imaging software to create such an image, or an external hardware image processor. One example of an open source imaging software is ImageMagick which allows for images to be manipulated and compressed. ImageMagick is available under the General Public License (GPL). The newly created reduced-sized image is stored onto local memory and the process flow continues to transmitting operation 306.

At transmitting operation 306, the reduced-sized image is transmitted to the web server where it will be processed and stored. The image is transmitted over the data manager's communication medium with the base station. The base station, which is connected to a network, will relay the information to the web server. In one embodiment of the invention two Qualcomm 5220 EVDO PCMCIA modems are used to connect the data manager to the base station. The Qualcomm modems provide a TCP/IP interface for the data manager. The data manager is then able to address TCP/IP packets directly to the web server which the base station passes on to the Internet or other TCP/UP network. The network will route the packets from the data manager to the web server using routing protocols such as RIP, BGP, and other routing protocols known to those skilled in the art. Upon the completion of the image transmitting operation 306, the process ends.

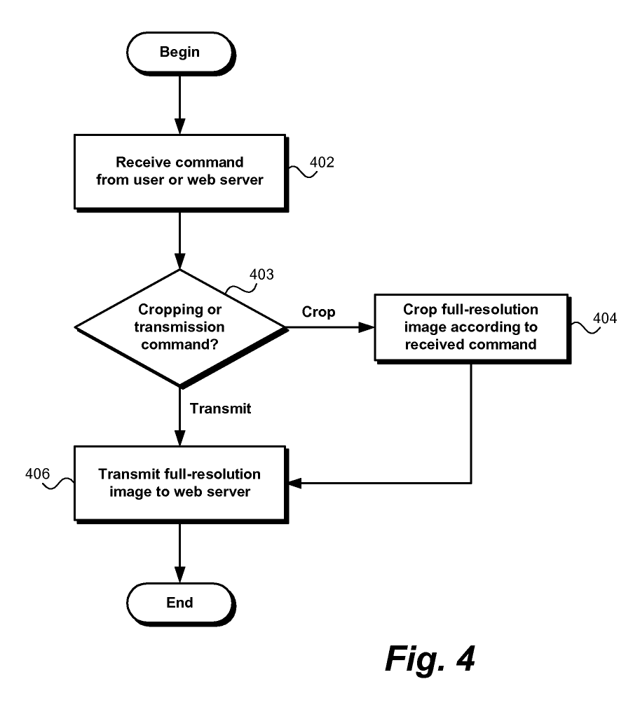

In FIG. 4, a flow chart of exemplary system operations preformed by the data manager when a command is received is shown.

Operation flow begins when a command is received from the user. This command can originate from the remote user or the web server, which acts as middle-ware for the remote user. Commands can be sent over the network using TCP/IP or other network based protocols such as Token Ring (IEEE 802.5). When a TCP/IP network is used to transmit commands TCP packets will be created by the web server or the remote viewer, which will encapsulate the command information. These packets will be routed over a TCP/IP network, such as the Internet, to reach the data manager. Such commands include, but are not limited to requests for full-resolution images, or requests for cropped versions of full-resolution images.

At receiving operation 402, the command received is decoded. If the command was sent over a TCP/IP network, the packet is decoded and the information that was encapsulated within the TCP packet is retrieved. After receiving operation 402, control passes to determining operation 403.

At determining operation 403 the command is interrupted and relayed to the appropriate module. For example, if the command contains a cropping directive, the operational flow moves to cropping operation 404. If the command contains a request for a full-resolution image, the operational flow moves to image transmission operation 406. It is important to note that the data manager is not limited to these commands but may in fact support other commands such as image rotation, or other image manipulation commands.

At cropping operation 404 a full-resolution image is cropped, a specific portion of it is removed, to form a cropped full-resolution image. The cropping command contains two sets of X,Y coordinates. These two sets of coordinates indicate the portion of the image that the remote viewer wishes to receive. In order to crop the image a software or hardware image processor is utilized. In one particular embodiment of the invention a software library such as ImageMagick is used to crop the image. The image as well as the two sets of coordinates are sent to the image processor which will create and store the newly cropped image onto local memory. Once the cropped full-resolution image is created the operation flow moves to image transmission operation 406.

At image transmitting operation 406, the full-resolution image or the cropped full-resolution image is transferred to the web server where it will be processed and stored. The image is transmitted over the data manager's communication medium with the base station. The base station, which is connected to a network, will relay the information to the web server. Upon the completion of the image transmitting operation 406, the process ends.

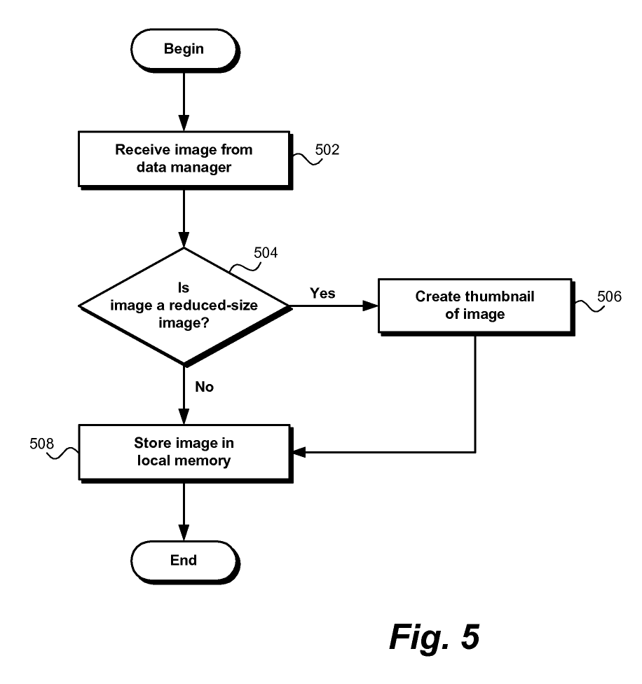

In FIG. 5, a flow chart of exemplary system operations preformed by the web server when an image is received is shown. The image originates from the data manager, which acts as middle-ware for the digital storage device and the web server.

Operation flow begins when an image is received from the data manager. At image receiving operation 502, the image is received from the data manager. The image can be a reduced image, cropped full-resolution image, or a full-resolution image. Images can be sent over the network using TCP/IP or other network based protocols such as Token Ring (IEEE 802.5). When a TCP/IP network is used to transmit images TCP packets will be created by the data manager, which will encapsulate the image(s). These packets will be routed over a TCP/IP network, such as the Internet, to reach the web server. Once receiving operation 502 is finished, control is passed to the identification unit 504.

At identification operation 504 the image is analyzed to determine if it is a full-resolution or reduced-size image. The data manager may determine the image type by its filename. For example, a reduced image may have a filename beginning with the letter “r” while a full-resolution image may begin with the letter “f”. If it is determined that the received image is a reduced-sized image the operation process moves to thumbnail creation operation 508, otherwise the operation processes moves to image storage operation 506.

At thumbnail creation operation 508, the reduced-sized image is resized and stored onto local memory. The resized image is a copy of the reduced-sized image with smaller dimensions. Specifically, the thumbnail image is a version of the reduced-sized image with smaller height and width properties. Furthermore, the thumbnail image may be of lower resolution than the reduced-sized image. Thus, the thumbnail image occupies considerably less memory than the reduced-size image and can be communicated to the remote viewer much fast than the reduced-size image.

It is contemplated that the web server uses imaging software or hardware to resize the image. In one particular embodiment of the invention a software library such as ImageMagick is used to crop the image. ImageMagick is available under the General Public License (GPL). Such dimensions allow for multiple thumbnail sized images to be viewed on a remote viewers screen at any one time. Once the thumbnail creation operation 508 finishes, the operation flow moves on to image storage operation 506.

At the storage operation 506, the received and created thumbnail image(s) are stored to local web server memory where they can later be recalled for transmission when requested by the remote viewer. Upon the completion of the image storage operation 506, the process ends. When another image is received by the data manager, the process is repeated.

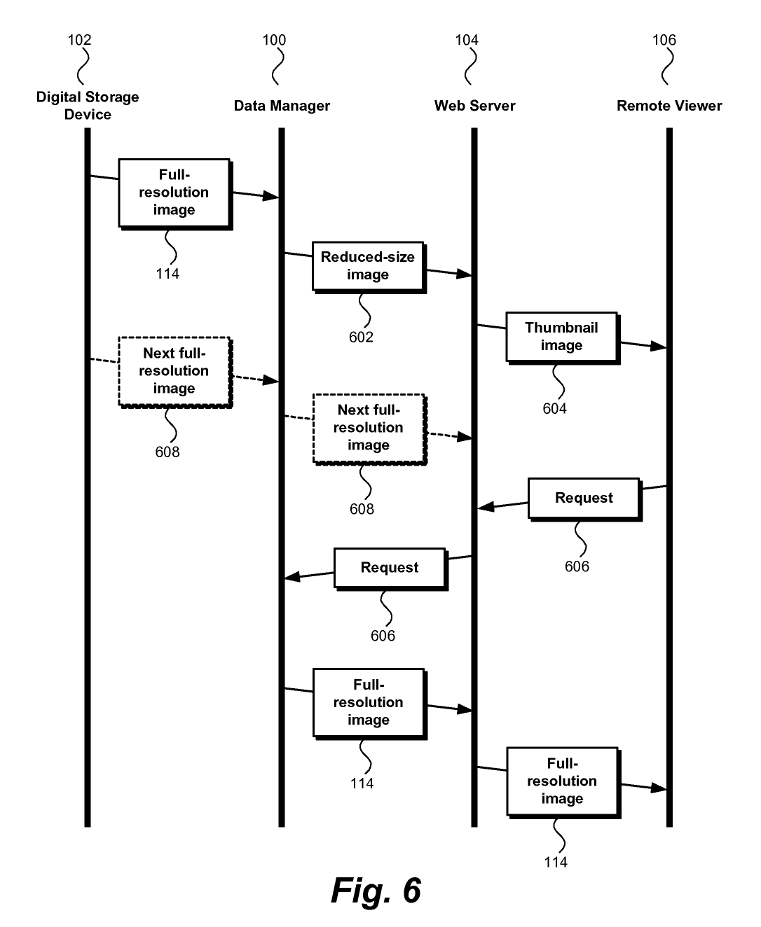

In FIG. 6, a chart is presented illustrating exemplary system operations preformed by the digital storage unit, data manager, web server and remote viewer is shown.

Operations start at the top left of the figure, where a full-resolution image 114 is transferred from the digital storage device 102 to the data manager 100 at a field location. The data manager 100 can receive and store the large, full-resolution image files quickly because it is located in close proximity to the digital storage device 102 and is connected via a high-speed wireless local area network (LAN). For example, the LAN may be connected using a WiFi 802.11g or next generation protocol and can transmit data at approximately 54 megabits per second. This means a full-resolution JPEG image from the digital storage device 102 can be transferred in just a few seconds to the data manager 100.

As discussed above, the full-resolution image 112 may be embodied in various formats known in the art. In a particular configuration of the invention, the digital storage device 102 is a digital camera. Nevertheless, it is contemplated that the digital storage device may include video recorders, cellular telephones, Personal Data Assistants (PDA), and MP3 players. Furthermore, the full-resolution image represents only one category of data contemplated by the invention. Other data categories that may be transferred by the digital storage device 102 include video and audio recordings.

After receiving the full-resolution image 114 from the digital storage device 102, the data manager 100 stores the image on a high-capacity storage device, such as a hard drive or compact flash card. The data manager 100 uses image resizing software to create a reduced-size image 602 based on the full-resolution image 114. In a particular embodiment of the invention, the size of the reduced-size image is configurable by a remote user having administrative privileges. Typically, the resolution of the reduced-size images is enough for the remote viewer 106 to be usable in an image selection process, but not enough to be used in publication.

If the data manager 100 is not transmitting data of higher priority, the reduced-size image 602 is transmitted from the data manager 100 to the web server 104. As discussed above, the data manager 100 may additionally transmit data associated with the reduced-size image 602, such as an audio or textual description of the image. Since the reduced-size image is much smaller than the original full-resolution image 114, it only takes a few seconds for the resized image to be sent to the web server 104 over a cell phone modem. To further increase the speed of transmission, the data manager 100 may divide the reduced-size image 602 into several equal-sized portions and the portions in parallel over a cell phone modem from the field location.

Once the web server 104 obtains the reduced-size image 602 from the data manager 100, it proceeds to make the image available to remote viewer 106. In one embodiment, the web server provides a listing of the available images on a web page accessible to the remote viewer 106. The web page may also include data associated with the reduced-size image 602, such as an audio or textual description of the image. In a particular embodiment of the invention, the web server 104 generates a thumbnail image 604 for teach reduced-size image 602 received. The thumbnail image 604 is generally substantially smaller than the reduced-size image 602, such that multiple thumbnail images can be displayed on a display screen. Both the thumbnail images and reduced-sized images are available for a remote viewer 106 to view. Thus, a remote viewer 106 may decide to view the thumbnail images currently stored on the web server.

It is contemplated that other methods may be used to provide the reduced-size and thumbnail images to the remote viewer 106 without departing from the spirit and scope of the present invention. For example, images on the web server 104 may be downloaded and viewed by the remote viewer through a file transfer protocol (FTP) port or a peer-to-peer network.

The remote viewer 106, after inspecting the reduced-size image 602 and/or thumbnail image 604, sends a request 606 to the web server 104 for a full resolution image 608. The request 606 may include, for example, a priority value for full resolution image 608, cropping directives and the desired resolution to be returned.

The web server 104 forwards the request 606 to the data manager 100. The data manager 100 complies with the request 606 and sends the requested full-resolution image 610 to the web server 104. Depending on the cropping constraints and desired resolution, it can take a few seconds for the data manager 100 to generate the larger image from the full-resolution file stored at the data manager 100, and a few minutes to transmit the newly created file to the web server 104. Once this operation is complete the request is completed.

The web server 104 receives the full-resolution image 606 and forwards it to the remote viewer 106. It is noted that the data manager 100 may continuously receive more full-resolution images 608 from the digital storage device 102 and transfer these images to the web server 104 while the operations described above are performed.

The foregoing description of the invention has been presented for purposes of illustration and description. It is not intended to be exhaustive or to limit the invention to the precise form disclosed, and other modifications and variations may be possible in light of the above teachings. For example, the present invention may be implemented as computer hardware, and can be embodied on a computer chip that accepts as input a full-resolution image and writes to output a compressed or reduced-sized image. Thus, the embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

That which is claimed is:

1. A method for selectively transmitting full-resolution digital images to a remote viewer from a field location, the method comprising:
connecting to a portable electronic device at the field location;
receiving at the field location at least one full-resolution image from the portable electronic device, the full-resolution image having a full-resolution storage size;
creating at the field location a reduced-sized image, the reduced-sized image having a reduced storage size that is smaller than the full-resolution image storage size;
transmitting at the field location the reduced-size image to a web server, the web server configured to display the reduced-size image for selection of the full-resolution image by the remote viewer;
receiving at the field location a request for the full-resolution image from the web server; and
transmitting at the field location the full-resolution image to the web server, the web server further configured to transmit the full-resolution image to the remote viewer.

2. The method of claim 1, further comprising:
receiving cropping directives to remove portions of the digital image;
removing at the field location the portions requested to be removed from the full-resolution image;
saving at the field location a cropped image, the cropped image being the full-resolution image with portions removed; and
transmitting at the field location the cropped image to the web server.

3. The method of claim 1, further comprising:
fragmenting at the field location the full-resolution image into at least two equally sized full-resolution image fragments; and
transmitting at the field location the full-resolution image fragments to the web server.

4. The method of claim 3, further comprising:
reassembling the full-resolution image fragments at the web server;
storing the assembled full-resolution image in web server local memory; and
transmitting from the web server the full-resolution image to the remote viewer.

5. The method of claim 3, further comprising:
transmitting at least one non-requested full-resolution image when no reduced-size images are being transmitted from the field location to the web server, the non-requested full-resolution image not requested by the remote viewer; and
stopping the transmission of the non-requested full-resolution image when a requested full-resolution image is requested by the remote viewer.

6. The method of claim 1, wherein transmitting the reduced-size image further includes transmitting an audio file associated with the reduced-size image.

7. The method of claim 1, further comprising receiving a priority level for transmitting at the field location the full-resolution image.

8. A portable data manager for selectively transmitting full-resolution digital images to a remote viewer from a field location, the data manager comprising:
an image receiving unit configured to receive at the field location at least one full-resolution image from the portable electronic device, the full-resolution image having a full-resolution storage size;
a local memory unit configured to store received and created images;
an image reducing unit configured to create a reduced-sized image having a storage size that is smaller than the full-resolution image storage size;
an image transmitting unit configured to send the reduced-sized image and full-resolution image;
a command receiving unit configured to receive a request for the full-resolution image; and
an image transmission unit configured to transmit the full-resolution image in response to a request for the full-resolution image.

9. The data manager of claim 8, further comprising a image cropping unit configured to remove, at the field location, portions of the full-resolution image according to received cropping directives and save, at the field location, a cropped image, the cropped image being the full-resolution image with portions removed.

10. The data manager of claim 8, further comprising an image fragmenting unit configured to split the full-resolution image into at least two equally sized full-resolution image fragments and save the image fragments in field location local memory.

11. The data manager of claim 8, wherein the transmitting unit is further configured to transmit non-requested full-resolution images to a web server when no other data is being transmitted and to stop transmitting non-requested full-resolution images when a request is received by the receiving unit.

12. The data manager of claim 8, further comprising a priority queue configured to determine which images to transmit to the web server.

13. A computer program product embodied in computer readable memory for selectively transmitting full-resolution digital images to a remote viewer from a field location, the computer program product comprising:
program code for connecting to a portable electronic device at the field location;
program code for receiving at least one full-resolution image from the portable electronic device, the full-resolution image having a full-resolution storage size;
program code for creating a reduced-sized image, the reduced-sized image having a reduced storage size that is smaller than the full-resolution image storage size;
program code for transmitting the reduced-size image to a web server, the web server configured to display the reduced-size image for selection of the full-resolution image by the remote viewer;
program code for receiving a request for the full-resolution image from the web server; and
program code for transmitting the full-resolution image to the web server, the web server further configured to transmit the full-resolution image to the remote viewer.

14. The computer program product of claim 13, further comprising:
program code for receiving cropping directives to remove portions of the digital image;
program code for removing the portions requested to be removed from the full-resolution image;
program code for saving a cropped image, the cropped image being the full-resolution image with portions removed; and
program code for transmitting the cropped image to the web server.

15. The computer program product of claim 13, further comprising:
program code for fragmenting the full-resolution image into at least two equally sized full-resolution image fragments; and
program code for transmitting the full-resolution image fragments to the web server.

16. The computer program product of claim 15, further comprising:
program code for reassembling the full-resolution image fragments at the web server;
program code for storing the assembled full-resolution image in web server local memory; and
program code for transmitting from the web server the full-resolution image to the remote viewer.

17. The computer program product of claim 16, further comprising:
program code for transmitting at least one non-requested full-resolution image when no reduced-size images are being transmitted from the field location to the web server, the non-requested full-resolution image not requested by the remote viewer; and
program code for stopping the transmission of the non-requested full-resolution image when a requested full-resolution image is requested by the remote viewer.

18. The computer program product of claim 13, wherein the program code for transmitting the reduced-size image further includes program code for transmitting an audio file associated with the reduced-size image.

19. The computer program product of claim 13, further comprising program code for receiving a priority level for transmitting at the field location the full-resolution image.
